(19) United States
(12) Patent Application Publication
(10) Pub. No.: US 2026/0303926 A1
(43) Pub. Date: Oct. 1, 2026

(54) SCALABLE AND OPTIMIZED EDGE AI ARCHITECTURE FOR INTERACTIVE STREAMING APPLICATIONS

(71) Applicant: NETFLIX, INC., Los Gatos, CA (US)

(72) Inventors: Weiguo ZHENG, San Jose, CA (US); Alan WONG, Sunnyvale, CA (US); Michael Aki SCHASSBERGER, San Ramon, CA (US); May-Chen MARTIN-KUO, Los Gatos, CA (US)

(21) Appl. No.: 19/570,808

(22) Filed: Mar. 18, 2026

Related U.S. Application Data
(60) Provisional application No. 63/777,554, filed on Mar. 25, 2025.

(51) Int. Cl. H04N 21/658; G06V 10/25; H04N 21/44; H04N 21/45; H04N 21/858

(52) U.S. Cl. CPC H04N 21/6581; G06V 10/25; H04N 21/44008; H04N 21/4532; H04N 21/8586; G06V 2201/07

(57) ABSTRACT

In some embodiments, a computer-implemented method for performing artificial intelligence (AI) processing in a streaming environment on an endpoint device comprises: obtaining media data associated with playback of content by a streaming application executing on the endpoint device; identifying, via at least one AI inference operation executed on the media data, an object represented within the media data; generating refined object data corresponding to the object; generating feature data associated with the object based on the refined object data; obtaining item information associated with the object based on a comparison between the feature data and reference data stored on the endpoint device; and outputting presentation data associated with the item information for display in association with the playback of the content.

### CROSS-REFERENCE TO RELATED APPLICATIONS

The present application claims the benefit of U.S. Provisional Application titled, “TECHNIQUES FOR IMPLEMENTING A SCALABLE AND OPTIMIZED EDGE AI ARCHITECTURE FOR INTERACTIVE STREAMING APPLICATIONS,” filed on Mar. 25, 2025, and having Serial No. 63/777,554. The subject matter of this related application is hereby incorporated herein by reference.

### BACKGROUND

Embodiments of the present disclosure relate generally to computer science, streaming and video processing technologies and, more specifically, to a scalable and optimized edge artificial intelligence (AI) architecture for interactive streaming applications.

### DESCRIPTION OF THE RELATED ART

Streaming environments benefit from many different tasks that can be performed using artificial intelligence (AI) models. Such tasks include, for example, capturing and analyzing video frames, running object detection in video frames, performing voice recognition, converting voice to text, and adjusting video and audio parameters.

Conventional techniques for executing AI models in streaming environments include various implementations of systems-on-chip (SOCs) in endpoint devices of users to enable accelerated execution of such AI models. SOCs typically differ in performance characteristics and in capability to implement the AI models due to variations in hardware configurations, including different processing units and hardware accelerators. In some cases, SOCs can more efficiently execute the AI models when the SOCs are optimized with specific processing units and hardware accelerators.

Additionally, other conventional techniques for executing AI models in streaming environments often rely on executing AI models in the cloud. In such approaches, the endpoint device communicates with the cloud, the cloud executes the AI models, and the output of the AI models – such as inference results – is transmitted back to the endpoint device. Such execution of AI models in the cloud often includes updating large cloud-based databases of metadata associated with media content.

Conventional techniques associated with SOCs that are optimized for specific processing units present several drawbacks. In particular, because different AI frameworks exist, no unified AI framework exists across the various implementations of SOCs, which results in fragmented implementations and integration complexities. For example, an AI model optimized for specific machine code inherently ties the AI model to a specific SOC architecture, thereby reducing compatibility across a range of other endpoint devices.

Conventional techniques that involve executing AI models in the cloud also present several drawbacks. For example, sending data to the cloud introduces latency problems and privacy concerns. Cloud-based processing can also require constant updating of large cloud-based databases and execution of heavy models in centralized infrastructures, which becomes increasingly difficult as requests for AI model execution are received from endpoint devices at scale. Such approaches introduce significant operational overhead and operational complexity due to a need to maintain compute resources, update databases, and perform similar operations.

Additionally, executing AI models in the cloud is associated with significant drawbacks in a context of live events. As live events can be global in nature, the inference results could be dependent on a country of a user, a user profile, and/or other personalization parameters. Performing personalization in a live manner simultaneously at a global level and down to a personal level is technically complex when processing is centralized, and cloud-based infrastructures can struggle to handle such bandwidth while live content is ingested and distributed.

As the foregoing illustrates, what is needed in the art are more effective techniques for executing AI on endpoint devices in streaming environments.

### SUMMARY OF THE EMBODIMENTS

One embodiment sets forth a method for performing artificial intelligence (AI) processing in a streaming environment on an endpoint device. According to some embodiments, the method includes obtaining media data associated with playback of content by a streaming application executing on the endpoint device; identifying, via at least one AI inference operation executed on the media data, an object represented within the media data; generating refined object data corresponding to the object; generating feature data associated with the object based on the refined object data; obtaining item information associated with the object based on a comparison between the feature data and reference data stored on the endpoint device; and outputting presentation data associated with the item information for display in association with the playback of the content.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques provide artificial intelligence (AI) model compatibility across a range of systems-on-chip (SOC) implementations. More specifically, the disclosed techniques support utilization of SOC implementations ranging from basic implementations to high-performance graphics processing units (GPUs), which enables execution of AI models across varying hardware platforms. More specifically, execution of AI models can be invoked without requiring specific formatting for a specific SOC, rather than requiring rewriting for each specific SOC on a given endpoint device, as with prior art approaches. Another technical advantage of the disclosed techniques is that processing is performed on the endpoint device rather than in the cloud, which reduces latency limitations associated with off-device processing, reduces processing strain on centralized infrastructure, and provides added privacy when implementing AI models into workflows with live events. Further, the disclosed techniques prevent display of unreliable detections such that more relevant outputs of AI models – such as inference results that have been filtered and refined – are displayed to the user.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a network infrastructure configured to support delivery of streaming content to endpoint devices.

FIG. 2 is a more detailed conceptual illustration of the endpoint device of FIG. 1, according to various embodiments.

FIG. 3 is a more detailed conceptual illustration of the edge AI architecture of FIG. 1, according to various embodiments.

FIG. 4 is a more detailed conceptual illustration of the object matching module of FIG. 3, according to various embodiments.

FIGS. 5A-5C illustrate flow diagrams for generating a match to an object within a video frame, according to various embodiments.

FIG. 6 is a more detailed illustration of a computing device that can implement the functionalities of any of the entities illustrated in FIG. 1, according to various embodiments.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

As described herein, conventional approaches for executing artificial intelligence (AI) models in streaming environments rely either on system-on-chip (SOC) hardware embedded in endpoint devices or on centralized cloud-based processing. SOC-based approaches can accelerate AI workloads such as video frame analysis, object detection, voice recognition, and audio/video optimization; however, differences in hardware architectures and AI frameworks across SOC vendors create fragmented implementations and integration challenges. AI models optimized for specific machine code or hardware accelerators often become tightly coupled to a particular SOC architecture, thereby limiting portability across devices. Cloud-based approaches, while avoiding device constraints, introduce other drawbacks including latency, privacy concerns, operational overhead, and scalability limitations due to the need for centralized infrastructure and large metadata databases. These limitations are particularly pronounced in live streaming scenarios, where personalization based on geography, user profiles, and contextual parameters must occur in real time at global scale, thereby rendering centralized processing complex and inefficient.

To address the foregoing drawbacks, techniques are disclosed herein for an artificial intelligence (AI) architecture that executes AI models directly on endpoint devices in a streaming environment. The architecture includes an edge AI service (EAIS) that mediates between a streaming application and one or more systems-on-chip (SOCs) present on the device. The EAIS receives events from the streaming application – such as requests for object detection, voice recognition, or media quality analysis – and dynamically selects and dispatches corresponding AI model operations to the SOCs, including loading models, executing inference using available processing units or hardware accelerators, and collecting inference outputs. The EAIS processes inference results by filtering unreliable detections, selecting relevant objects, optionally interacting with databases, and returning structured outputs (e.g., links, text, or adjustment parameters) to the streaming application. The architecture further includes an edge AI interface (EAIF) that standardizes AI model invocation across different SOC implementations by routing requests through vendor-specific EAIF libraries that encapsulate hardware-specific execution details while conforming to a common interface. Accordingly, the architecture enables AI models to be executed across devices with different SOC vendors without modifying the streaming application or EAIS. The architecture also supports AI-based streaming enhancements such as object detection through a two-pass execution framework. In a first pass, a lightweight detection model identifies objects within captured video frames and generates bounding boxes, labels, and confidence scores while optionally filtering results based on user context. In a second pass, feature extraction and matching are performed on cropped object regions to identify specific products or brands using a local database or simplified model, enabling generation of contextual outputs such as URLs while minimizing computational load. This approach allows efficient, privacy-preserving, and context-aware AI processing directly on endpoint devices.

At least one technical advantage of the disclosed techniques relative to the prior art is that the disclosed techniques provide artificial intelligence (AI) model compatibility across a range of systems-on-chip (SOC) implementations. More specifically, the disclosed techniques support utilization of SOC implementations ranging from basic implementations to high-performance graphics processing units (GPUs), which enables execution of AI models across varying hardware platforms. More specifically, execution of AI models can be invoked without requiring specific formatting for a specific SOC, rather than requiring rewriting for each specific SOC on a given endpoint device, as with prior art approaches. Another technical advantage of the disclosed techniques is that processing is performed on the endpoint device rather than in the cloud, which reduces latency limitations associated with off-device processing, reduces processing strain on centralized infrastructure, and provides added privacy when implementing AI models into workflows with live events. Further, the disclosed techniques prevent display of unreliable detections such that more relevant outputs of AI models – such as inference results that have been filtered and refined – are displayed to the user.

These technical advantages represent one or more technological advancements over prior art approaches.

### System Overview

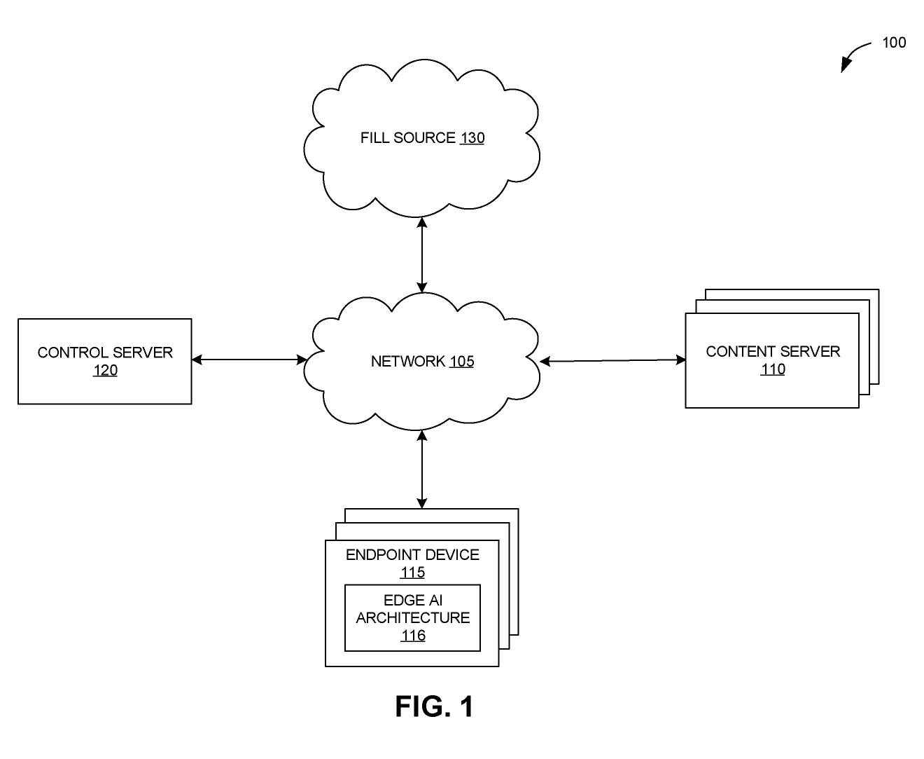

FIG. 1 illustrates a network infrastructure 100 configured to support delivery of streaming content to endpoint devices 115. As shown, the network infrastructure 100 includes content servers 110, a control server 120, fill sources 130, and endpoint devices 115, each of which is connected using a communications network 105. The endpoint devices 115 include, without limitation, an edge AI architecture 116.

The content servers 110 are configured to provide streaming media content to the endpoint devices 115 over the network 105. The control server 120 can coordinate distribution, control, or management functions associated with the streaming content.

The fill sources 130 can provide additional media sources or supplemental content that is delivered through the network 105. The endpoint devices 115 receive streaming content over the network 105 and execute local processing, including execution of the edge AI architecture 116 as described herein.

Each endpoint device 115 communicates with one or more content servers 110 (also referred to herein as caches or nodes) using the network 105 to download content such as textual data, graphical data, audio data, video data, and other types of data. The downloadable content, also referred to herein as a file, is then presented to a user of one or more endpoint devices 115. In various embodiments, the endpoint devices 115 can include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content such as text, images, video, and/or audio content to a user.

Each content server 110 can include a web server, database, and server application (not illustrated in FIG. 1) configured to communicate with the control server 120 to determine the location and availability of various files that are tracked and managed by the control server 120. Each content server 110 can further communicate with the fill sources 130 and one or more other content servers 110 to “fill” each content server 110 with copies of various files. In addition, content servers 110 can respond to requests for files received from endpoint devices 115. The files can then be distributed from the content servers 110 or using a broader content distribution network. In some embodiments, content servers 110 enable users to authenticate (e.g., using a username and password) to access files stored on content servers 110. Although only a single control server 120 is shown in FIG. 1, in various embodiments, multiple control servers 120 may be implemented to track and manage files.

In various embodiments, the fill source 130 can include an online storage service (e.g., Amazon® Simple Storage Service, Google® Cloud Storage, etc.) in which a catalog of files, including thousands or millions of files, is stored and accessed to fill the content servers 110. Although only a single fill source 130 is shown in FIG. 1, in various embodiments, multiple fill sources 130 may be implemented to service requests for files. Further, as is well understood, any cloud-based services can be included in the architecture of FIG. 1 beyond fill source 130 to the extent desired or necessary.

The edge AI architecture 116 includes hardware and software components that enable on-device local AI processing on the endpoint device 115. The edge AI architecture 116 enables execution of AI models on the endpoint device 115, such as an embedded system that implements an SOC.

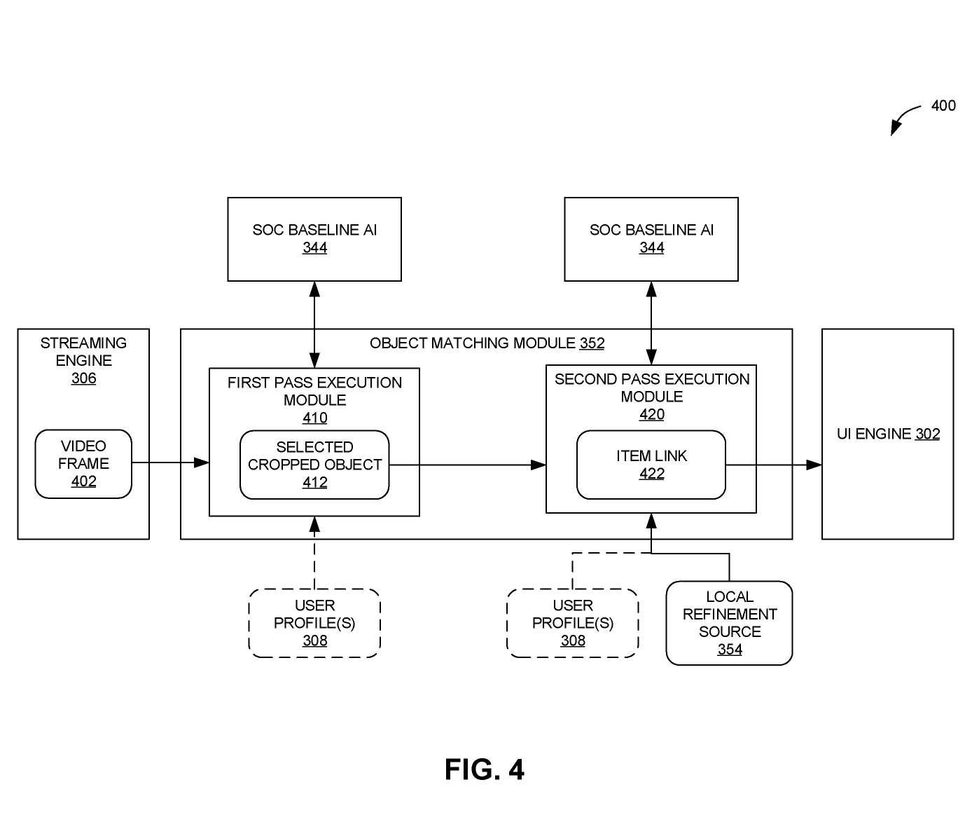

Notably, in such embedded systems, safety is an issue for on-device AI models because on-device processing can generate inference results that should not be provided directly for display to the user without additional processing. The edge AI architecture 116 provides a framework for executing AI models on the endpoint device 115 while addressing such safety issues because the edge AI architecture 116 enables processing of inference results before presentation, as described in greater detail in conjunction with FIG. 4.

The edge AI architecture 116 enables execution of different AI tasks including, but not limited to, running object detection, text recognition, voice capture, and voice recognition. In some embodiments, the endpoint device 115 uses the edge AI architecture 116 to capture voice, recognize voice, and convert voice to text. In some embodiments, the edge AI architecture 116 is used for video quality and audio quality mode setting. In some embodiments, the edge AI architecture 116 is used to identify picture quality and audio quality and enhance streaming service quality. In some embodiments, the edge AI architecture 116 does not feed information back to the cloud due to safety or privacy concerns and avoids cloud roundtrips due to latency that impacts service quality. In some embodiments, the edge AI architecture 116 is used for detecting objects in video frames and matching associated real-world items, as described in greater detail in conjunction with FIG. 4.

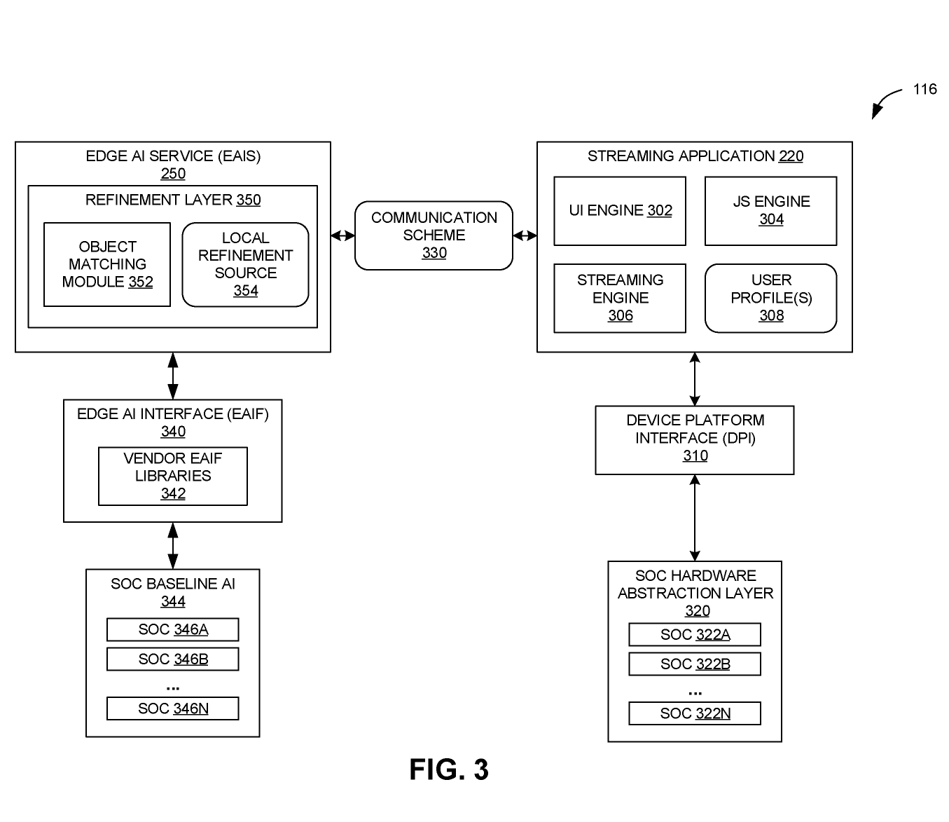

Notably, different SOCs have different frameworks such that no unified framework exists. In such cases, an SOC vendor (e.g., a developer of the SOC) controls how AI models are executed and optimized on a given SOC. Advantageously, the edge AI architecture 116 provides an interface that allows software to communicate with the SOCs regardless of the SOC vendor (e.g., without requiring a streaming application to implement SOC-specific execution logic), as described in greater detail in conjunction with FIG. 3. In such a manner, the edge AI architecture 116 enables AI tasks to be invoked while permitting SOC-specific execution to remain with the SOC vendor.

In some embodiments, performance of the edge AI architecture 116 depends on vendor-specific AI model optimizations, data format handling, and quantization and pruning techniques. In some embodiments, SOC vendors include enhancements that improve execution of AI models on the SOCs and enable improved performance for edge AI use cases in streaming services.

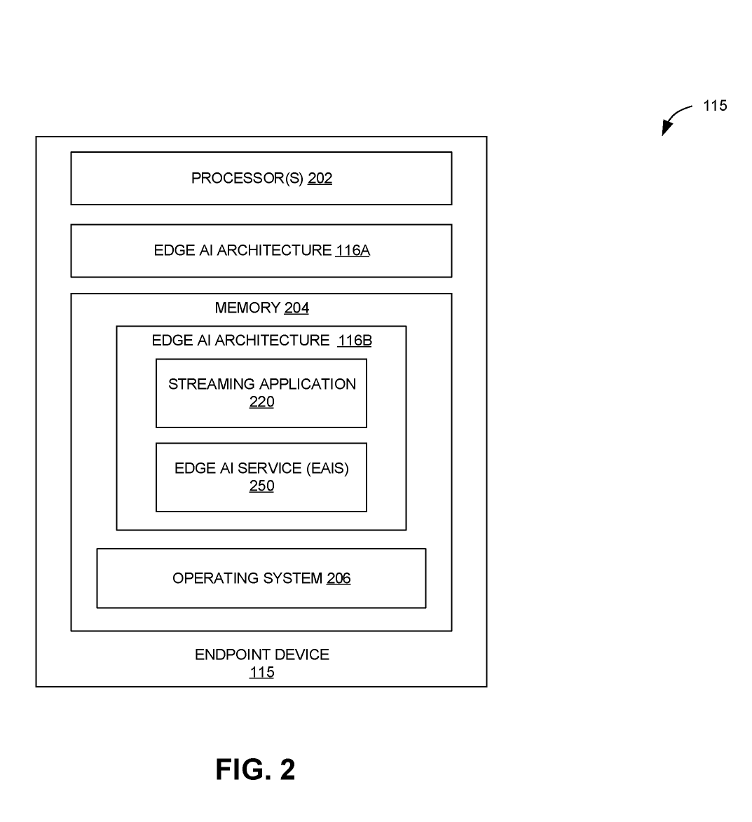

FIG. 2 is a more detailed conceptual illustration of the endpoint device 115 of FIG. 1, according to various embodiments. FIG. 2 includes, without limitation, the endpoint device 115. The endpoint device 115 includes, without limitation, processor(s) 202, a memory 204, and the edge AI architecture 116A. The memory 204 includes the edge AI architecture 116B and an operating system 206. The edge AI architecture 116B includes a streaming application 220 and an edge AI services (EAIS) 250.

The AI architecture 116A includes hardware elements that enable execution of AI models on the endpoint device 115. For example, the AI architecture 116A includes one or more SOCs that enable AI processing on the endpoint device 115. The hardware elements of the AI architecture 116A are discussed in greater detail in conjunction with FIG. 3.

The processor(s) 202 can be any instruction execution system, apparatus, or device capable of executing instructions. For example, the processor(s) 202 can include a central processing unit (CPU), a graphics processing unit (GPU), a controller, a microcontroller, a state machine, an SOC, or any combination thereof.

The memory 204 stores content for use by the processor(s) 202. The memory 204 can be one or more readily available memories, such as random access memory (RAM), read-only memory (ROM), a floppy disk, a hard disk, or any other form of digital storage, local or remote. In some embodiments, storage (not shown) can supplement or replace the memory 204. The memory 204 can include any number and type of external memories that are accessible to the processor(s) 202. For example, and without limitation, the memory 204 can include a Secure Digital Card, an external flash memory, a portable compact disc read-only memory (CD-ROM), an optical storage device, a magnetic storage device, or any suitable combination of the foregoing.

The operating system 206 can be any feasible operating system capable of executing the streaming application 220. For example, the operating system 206 could include Linux®, Microsoft Windows®, and/or Android™.

The edge AI architecture 116B includes software elements that enable coordination and management of AI models on the endpoint device 115. The software elements of the edge AI architecture 116B are discussed in greater detail in conjunction with FIG. 3.

The streaming application 220 includes a video player with a player state. The streaming application 220 can request execution of AI models by communication with the edge AI service 250. The streaming application 220 receives processed inference results from the edge AI service 250. The streaming application 220 includes a UI engine for displaying results generated based on the inference results, as discussed in greater detail in conjunction with FIG. 3.

The edge AI service 250 is a device-level service layer positioned between the streaming application 220 and SOCs. Such a device-level service layer coordinates AI tasks without implementing SOC-specific hardware logic. The edge AI service 250 prevents hardware-generated results from being directly exposed to the streaming application 220 by adding additional filtering, refinement, and contextual processing for reliability. The edge AI service 250 mediates between the streaming application 220 and SOC-based AI execution by controlling when AI tasks (e.g., use of specific AI models) are requested, how results are interpreted, and how outputs are provided for presentation.

In some embodiments, the edge AI service 250 listens to the streaming application 220 and subscribes to player state notification events of the streaming application 220. The edge AI service 250 can request a video frame capture from the streaming application 220 when a condition such as pause mode is detected, as discussed in greater detail in conjunction with FIG. 4. In some embodiments, the edge AI service 250 can generate inference results including labels, confidence levels, and bounding boxes associated with objects in media content streamed by the streaming application 220. The edge AI service 250 filters and processes such inference results for filtering refinement and matching to improve reliability prior to display in the streaming application 220, as described in greater detail in conjunction with FIG. 4.

In some embodiments, the edge AI service 250 can adjust video and quality settings based on inference results. Such adjustments include optimizing contrast sharpness and spatial audio processing. In some embodiments, the edge AI service 250 enables real-time semantic segmentation, gesture recognition, and/or AI-powered scene understanding.

FIG. 3 is a more detailed conceptual illustration of the edge AI architecture 116 of FIG. 1, according to various embodiments. FIG. 3 includes, without limitation, the streaming application 220, the edge AI service 250, a device platform interface 310, an SOC hardware abstraction layer 320, a communication scheme 330, an edge AI interface (EAIF) 340, and an SOC baseline AI 344. The edge AI service 250 includes, without limitation, a refinement layer 350. The edge AI interface 340 includes vendor EAIF libraries 342. The refinement layer 350 includes, without limitation, an object matching module 352 and a local refinement source 354. The streaming application 220 includes, without limitation, a user interface (UI) engine 302, a JavaScript (JS) engine 304, a streaming engine 306, and one or more user profile(s) 308. The SOC hardware abstraction layer 320 includes one or more SOCs 322. The SOC baseline AI 344 includes one or more SOCs 346 (e.g., SOC 346A through SOC 346N).

The streaming application 220 is an application executing on the endpoint device 115 that manages media playback and user interaction. The streaming application 220 interfaces with the edge AI service 250 using the communication scheme 330. The streaming application 220 is responsible for configuring the user profile(s) 308 and controlling playback of media content.

The UI engine 302 renders a user interface on the endpoint device 115. The UI engine 302 can be used to display user interface elements, such as bounding boxes, quick response (QR) codes, and other AI outputs generated based on processed results. In some embodiments, the UI engine 302 receives processed results from the JS engine 304 and displays the processed results for user interaction.

The JS engine 304 executes JavaScript on the endpoint device 115. In some embodiments, the JS engine 304 uses a JavaScript Object Notation (JSON) eventing application programming interface (API), included in the communication scheme 330, to enable communication between the streaming application 220 and the edge AI service 250. In such embodiments, the JSON eventing API enables structured message exchange using JSON-formatted events. The JS engine 304 can transmit requests to the edge AI service 250 and receive generated results as structured JSON messages using the communication scheme 330. The JS engine 304 makes such generated results available to other elements of the streaming application 220, such as the UI engine 302 and the streaming engine 306. The JS engine 304 sends AI task requests through the communication scheme 330 and receives processed results through the communication scheme 330. In some embodiments, the JS engine 304 can be updated without firmware changes. Such updates enable modification of application-level logic without modifying SOC-level software. In some embodiments, the JS engine 304 executes JavaScript and directly consumes JSON-formatted messages exchanged through the communication scheme 330.

The user profile(s) 308 represent user-specific profile information associated with one or more users of the streaming application 220. The user profile(s) 308 enable personalization of inference results generated through the edge AI service 250, as discussed in greater detail in conjunction with FIG. 4. The user profile(s) 308 can include object cohorts. The object cohorts refer to grouping that determines categories of objects of interest for a given user profile 308. The object cohort can determine types of objects that are prioritized during processing of objects in a video frame rather than identifying objects within the video frame. In contrast to a server-side approach that identifies everything and necessitates carrying a large set of metadata down to the endpoint device 115, use of the object cohorts allows selective identification of objects relevant to the user profile(s) 308. Examples of object cohorts could include a travel interest cohort and a fashion interest cohort.

In some embodiments, the user profile(s) 308 include user interests, object preferences, geographic region, previously selected objects, object cohorts, and/or session-level viewing context associated with the streaming session.

In some embodiments, the streaming application 220 can maintain multi-level profile tracking within the user profile(s) 308. Multi-level profile tracking can include persistent user preferences associated with an account and/or session-level context associated with a current viewing session. Persistent preferences can represent longer-term interests associated with the viewer. Session-level context can represent temporary conditions associated with a current viewing environment.

In some embodiments, the user profile(s) 308 influence objects of interest in a first pass of the object matching module 352, as described in greater detail in conjunction with FIG. 4. The object cohort can be contextual for the user associated with the user profile(s) 308. Examples of different interests include clothing, jewelry, actors, background setting, locations, landmarks, and/or the like. For example, if the user profile(s) 308 indicate interest in landmarks, a first pass could prioritize detection of landmarks in the video frame. In another example, if the user profile(s) 308 indicate a focus on fashion, the first pass could prioritize detections of handbags, watches, and jewelry objects. In some embodiments, given a detected object in the video frame, in a second pass, the user profile(s) 308 also enable running a more refined search within a database of items (e.g., the local refinement source 354) to find a match for the detected object in the database.

Advantageously, use of the user profile(s) 308 in object matching workflows reduces unnecessary processing by avoiding detection and matching operations for objects that are unlikely to be relevant to the viewer. Conventional server-side techniques often identify all objects within a scene and transmit large metadata sets to an endpoint device. In contrast, the techniques described herein can limit object detection and matching to user-relevant objects, thereby reducing processing overhead and reducing metadata transmission.

Over time, the streaming application 220 can adjust prioritization based on user selections made during prior interactions. For example, when a viewer shows interest in certain objects or categories of objects, the streaming application 220 can update the user profile(s) 308 to reflect such preferences. Subsequent executions of the first pass execution module 410 and the second pass execution module 420 can then prioritize detection and matching of objects aligned with the updated preferences, which enables adaptive personalization of detected objects and matching results.

The device platform interface (DPI) 310 interfaces between the streaming application 220 and the SOC hardware abstraction layer 320. The device platform interface 310 provides communication mechanisms that allow the streaming application 220 to exchange control information and status information with underlying device components (e.g., the SOCs 322) without directly accessing hardware-specific logic. The device platform interface 310 enables the streaming application 220 to request device state information and issue control commands that are implemented through lower-level system components rather than directly interacting with the SOCs 322.

The SOC hardware abstraction layer 320 provides an abstraction of underlying SOCs 322. The SOC hardware abstraction layer 320 is a software layer that presents a consistent interface to higher-level components while encapsulating hardware-specific implementation details. The SOC hardware abstraction layer 320 provides a standardized interface to the streaming application 220 using the device platform interface 310. The SOC hardware abstraction layer 320 accommodates differences in architecture, instruction sets, memory bandwidth, hardware accelerators, etc. across different SOC hardware while maintaining a consistent interface to higher-level software components.

The SOC 322A through SOC 322N, collectively referred to as the SOCs 322, can represent different SOC hardware implementations. The SOCs 322 can include different processing units and hardware accelerators, including processing units and hardware accelerators from different SOC vendors.

The communication scheme 330 enables communication between the streaming application 220 and the edge AI service 250. The communication scheme 330 allows the streaming application 220 to transmit requests to the edge AI service 250 and allows the edge AI service 250 to return results to the streaming application 220. In some embodiments, the communication scheme 330 is implemented as JSON eventing. JSON eventing facilitates communication between the edge AI service 250 and the streaming application 220 using structured JSON messages.

In some embodiments, the communication scheme 330 transfers requests such as player state monitoring, video frame capture, text payload transmission for voice recognition, picture quality mode settings, audio quality mode settings, and QR code generation. The communication scheme 330 transfers such lightweight messages between the streaming application 220 and the edge AI service 250, while heavy compute operations remain within device-level components.

The refinement layer 350 operates within the edge AI service 250. The refinement layer 350 extracts object features or embeddings directly from media content using the object matching module 352. The refinement layer 350 implements a two-pass model. In a first pass, objects are initially identified using general object detection models executed through the edge AI interface 340 and SOC baseline AI 344, as discussed in greater detail in FIG. 4. In a second pass, objects corresponding to identified portions of the media content undergo feature or embedding analysis. The resulting feature or embedding data is either stored in a database or utilized by a simplified model, known as the local refinement source 354. In some embodiments, data in the local refinement source 354, based on the detected object, is displayed to the user, as described in greater detail in conjunction with FIG. 4.

In some embodiments, the refinement layer 350 extracts objects determined by bounding box positions and performs feature or embedding analysis on objects rather than on an entire video frame. The refinement layer 350 constructs a database or refinement model by storing embedding data in the local refinement source 354 or by updating a simplified model included in the local refinement source 354. Advantageously, by reusing objects with a bounding box, the refinement layer 350 improves object identification accuracy for the edge AI service 250. Limiting embedding or feature size for each object reduces overall database or model size and improves performance and accuracy of the edge AI service 250.

Notably, in many streaming environments, media content provided by the streaming engine 306 is subject to content protection constraints. As a result, video frames captured from the streaming engine 306 can be provided at a reduced resolution or may be downsampled prior to processing on the endpoint device 115. Downsampled frames reduce the accuracy of AI tasks such as object detection and feature extraction because visual details become more difficult to distinguish, thereby limiting reliable identification of matches. Increasing model size or computational complexity to compensate for reduced visual details is not practical on the endpoint devices 115 due to processing limitations associated with the embedded system environment. Advantageously, the refinement layer 350 addresses such constraints by operating on cropped regions around an object rather than an entire video frame. By limiting feature extraction to cropped regions, the refinement layer 350 improves identification accuracy.

The object matching module 352 is responsible for execution within the refinement layer 350. The object matching module 352 generates a cropped region around a detected object and executes a match against the local refinement source 354, as discussed in greater detail in conjunction with FIG. 4. In some embodiments, the object matching module 352 identifies a specific item (e.g., a brand item or product item) corresponding to the object and obtains a uniform resource location (URL) associated with the matched item. In some embodiments, the object matching module 352 supports close match scenarios in which an exact brand item is not available. The object matching module 352 provides output including the URL to the edge AI service 250 for display by the streaming application 220 and/or for QR code generation and display.

In an example use case involving a captured video frame from a selection of media content, a handbag is located using an object detection model executed during a first pass using SOC baseline AI 344. The object detection model locates the handbag and identifies the handbag as an object category but does not identify a specific type or brand. A bounding box is used to crop the handbag from the captured video frame. The cropped handbag image is processed on the endpoint device 115 because the cropped handbag image is small in size, and the cropped handbag image is thereby optimized for embedded systems. The object matching module 352 extracts a feature representation from the cropped handbag image and runs a match on the local refinement source 354. The object matching module 352 identifies the brand of the handbag and provides a URL for additional information. The URL is converted into a QR code for presentation. A user can capture the QR code to access a website selling the handbag or providing additional information.

Advantageously, such a device-side approach includes high efficiency. Specifically, for live content, including events such as the Olympics, a cloud server may not be feasible, whereas the endpoint device 115 is more flexible, lightweight, and enables real time execution compared to the cloud server. In environments with many live feeds around the world, avoiding cloud server processing during ingestion of live assets reduces operational strain.

In some embodiments, the local refinement source 354 is implemented on the endpoint device 115 as a database. The local refinement source 354 can store feature or embedding data corresponding to objects within a bounding box identified within a video frame of media content. The local refinement source 354 is used for match operations during a second pass performed by the object matching module 352. In some embodiments, the local refinement source 354 stores brand information and associated URLs corresponding to stored feature or embedding data. Advantageously, the local refinement source 354 does not transmit full feature data back to a cloud server. In some embodiments, the local refinement source 354 is alternatively implemented as a simplified model.

The edge AI interface 340 is an abstraction layer positioned between the edge AI service 250 and SOC baseline AI 344. The edge AI interface 340 standardizes invocation and routing of AI execution, while hardware-specific implementations remain within vendor EAIF libraries 342 and SOC baseline AI 344. The edge AI interface 340 provides a common interface for invoking AI functionality across different SOC vendors.

In some embodiments, the edge AI interface 340 provides structured code for loading AI models, running inference, and returning inference results. The AI models can include object detection models such as YOLO models and classification models such as resnet50. The edge AI interface 340 dispatches inference requests received from the edge AI service 250 and routes inference execution requests to a correct vendor EAIF library 342 corresponding to a target SOC 346. The edge AI interface 340 exposes device AI capabilities through a feature set declaration. The feature set declaration can include enumerations identifying capabilities such as AI super resolution, AI picture quality, AI audio quality, object detection, voice recognition, and/or voice to text. Exposing device AI capabilities allows the system to identify capabilities supported by a given SOC 346 and enables selection of AI tasks supported by the given SOC 346 rather than assuming uniform functionality across devices.

In some embodiments, the edge AI interface 340 enables device certification by executing test vectors including test images and audio clips to verify accuracy and performance of SOC baseline AI 344. In such embodiments, the edge AI interface 340 can assess metrics including number of detected objects, confidence levels, and performance benchmarks. The edge AI interface 340 can support a range of SOC implementations from basic configurations to configurations including high-performance GPUs. The edge AI interface 340 is extended to support additional object detection models, semantic segmentation, advanced voice recognition, and AI super resolution. In some embodiments, the edge AI interface 340 does not contain hardware-specific execution code and does not implement inference at a silicon level. In some embodiments, the edge AI interface 340 integrates with third-party AI frameworks including but not limited to Google NNAPI, TensorFlow Lite, PyTorch Mobile, and/or ONNX Runtime.

Vendor EAIF libraries 342 are libraries supplied by SOC vendors that implement hardware-specific functionality and interact with the edge AI interface 340. Each SOC vendor provides a corresponding vendor EAIF library 342 that adheres to the interface definition exposed by the edge AI interface 340. The vendor EAIF libraries 342 include SOC-specific execution logic and enable a callable structure to the edge AI interface 340.

In some embodiments, a vendor EAIF library 342 loads compiled AI models optimized for a corresponding SOC 346 to be executed using accelerators on the SOCs 346 such as neural processing units (NPUs), GPUs, CPUs, and/or hardwired application specific integrated circuits (ASICs). The vendor EAIF library 342 performs hardware-optimized execution according to the architecture of the associated SOC 346 and returns inference results to the edge AI interface 340.

SOC baseline AI 344 represents baseline edge AI functions provided by SOC vendors as pre-optimized inference modules. Pre-optimized inference modules refer to AI model implementations that have been compiled, tuned, and configured by an SOC vendor for efficient execution. Baseline AI refers to foundational AI capabilities that are natively supported by SOCs 346, as opposed to higher-level service logic implemented within the edge AI service 250 or refinement logic implemented within the refinement layer 350.

SOCs 346, represented as SOC 346A, SOC 346B, through SOC 346N, represent different SOC implementations within the edge AI architecture 116. The SOCs 346 can differ in performance characteristics, including processing capability and memory bandwidth. Further, the SOCs 346 can differ in inference model implementations based on vendor-specific compilation and optimization techniques. The SOCs 346 can support different AI capabilities as identified through the feature set declaration exposed by the edge AI interface 340.

In operation, the streaming application 220 communicates with the edge AI service 250. The edge AI service 250 invokes the edge AI interface 340 to initiate AI execution. The edge AI interface 340 dispatches an inference request and routes the inference request to a correct vendor EAIF library 342 associated with the target SOC 346. The vendor EAIF library 342 executes the AI model on the appropriate SOC 346 and returns inference results to the edge AI interface 340. The edge AI interface 340 returns the inference results to the edge AI service 250, and the edge AI service 250 performs filtering, refinement, and matching prior to presentation through the streaming application 220.

FIG. 4 is a more detailed conceptual illustration of the object matching module 352 of FIG. 3, according to various embodiments. FIG. 4 includes, without limitation, a first pass execution module 410 and a second pass execution module 420. The first pass execution module 410 communicates with the SOC baseline AI 344, the streaming engine 306, and the user profile(s) 308. The first pass execution module 410 generates a selected cropped object 412. The streaming engine 306 includes a video frame 402. The second pass execution module 420 receives the selected cropped object 412 and generates an item link 422. The second pass execution module 420 communicates with the SOC baseline AI 344 and the local refinement source 354, and outputs the item link 422 to the UI engine 302.

The video frame 402 corresponds to a video frame captured during a pause state of the streaming engine 306. In some embodiments, the streaming engine 306 notifies the object matching module 352 of the pause state. The streaming engine 306 provides the video frame 402 to the object matching module 352. Advantageously, the video frame 402 is processed locally on the endpoint device 115. The video frame 402 is not received from the control server 120, the content server 110, or the fill source 130 for purposes of subsequent object matching.

In operation, the object matching module 352 operates as follows. The object matching module 352 subscribes to player state notification events exposed by the streaming engine 306. In some embodiments, the subscription occurs through the edge AI service 250 using the communication scheme 330.

Then, the object matching module 352 receives notification of a play state of the streaming engine 306 in pause mode. The streaming engine 306 transmits such a paused play state notification. The object matching module 352 receives the play state notification from the streaming engine 306.

Then, the object matching module 352 captures the video frame 402. In some embodiments, the object matching module 352 receives the video frame 402 from the streaming engine 306. In some embodiments, the object matching module 352 captures the video frame 402 directly from the streaming engine 306 in response to the paused play state. The object matching module 352 begins execution using the video frame 402 as input to the first pass execution module 410. The video frame 402 remains on the endpoint device 115 and is processed locally without transmission to external devices.

Then, the object matching module 352 executes a first pass using an object detection model. The object matching module 352 invokes the first pass execution module 410 to perform object detection on the video frame 402 as described in greater detail below. The first pass execution module 410 applies the object detection model on the video frame 402. The object detection model outputs one or more objects based on the video frame 402. The first pass execution module 410 then selects an object within the video frame 402. The first pass execution module 410 selects the object based on confidence levels and, in some embodiments, relevance to the user profile(s) 308. Specifically, in some embodiments, the user profile(s) 308 influence which object categories are considered relevant during selection of the object. In some embodiments, the first pass execution module 410 combines the video frame 402 with profile-derived context obtained from the user profile(s) 308 for object detection. The object detection model can receive input from the video frame 402 together with contextual information describing user interests or preferences when determining which objects to detect or prioritize.

The first pass execution module 410 generates the selected cropped object 412 by using inference results to crop out the selected object. Advantageously, cropping reduces data size prior to additional processing by the second pass execution module 420. In some embodiments, the first pass execution module 410 combines the video frame 402 with profile-derived context obtained from the user profile(s) 308 for input used for bounding box extraction.

The selected cropped object 412 corresponds to the object selected within the video frame 402 and subsequently cropped out of the video frame 402. The selected cropped object 412 includes image data corresponding only to the selected object and excludes surrounding portions of the video frame 402. Cropping reduces the amount of image data to be processed by the second pass execution module 420.

Then, the object matching module 352 executes a second pass to obtain a match to the selected cropped object 412. The selected cropped object 412 is input to the second pass execution module 420. The second pass execution module 420 performs feature extraction on the selected cropped object 412, as described in greater detail below. In some embodiments, the feature extraction uses computer vision processing executed on the endpoint device 115. The object matching module 352 compares the extracted features against the local refinement source 354 to determine a match, as described in greater detail below. In some embodiments, the matching can result in an exact match such as an item from a specific brand or a close match based on similarity between the extracted features and entries stored in the local refinement source 354. In some embodiments, personalization is applied using the user profile(s) 308 to select geographically or contextually relevant results from among potential matches. Upon identification of a match, the item link 422 is generated based on data obtained from the local refinement source 354.

The item link 422 corresponds to data associated with the matched object identified by the second pass execution module 420. The item link 422 can include a URL, a brand identifier, and/or other reference information associated with a corresponding real-world item. In some embodiments, the item link 422 is derived from data stored in the local refinement source 354.

Then, the object matching module 352 transmits the item link 422 to the UI engine 302 for display. The UI engine 302 then renders bounding box overlays corresponding to the selected cropped object 412 and a QR code representation associated with the URL of the item link 422. In some embodiments, the display is rendered on top of the paused video frame 402.

The first pass execution module 410 operates as follows. First, the first pass execution module 410 optionally receives the user profile(s) 308. The user profile(s) 308 are included in the streaming application 220 and provided to the first pass execution module 410 through the object matching module 352.

Then, the first pass execution module 410 receives the video frame 402 from the streaming engine 306. In some embodiments, the first pass execution module 410 receives a video stream from the streaming engine 306 and captures the video frame 402 in response to the paused player state. The video frame 402 is provided as input to the first pass execution module 410 for object detection processing.

Then, the first pass execution module 410 executes an object detection model on the video frame 402 to generate inference results. The first pass execution module 410 invokes the SOC baseline AI 344 using the edge AI interface 340. The edge AI interface 340 dispatches execution of the object detection model to an appropriate vendor EAIF library 342 corresponding to the SOCs 346. The SOCs 346 execute object detection on the video frame 402. In some embodiments, the object detection model includes, e.g., YOLO8, YOLO11, ResNet50, and/or other object detection models. The object detection model can identify multiple candidate objects within the video frame 402. In some embodiments, the inference results include labels, object coordinates, bounding boxes, and confidence levels corresponding to detected objects within the video frame 402.

Then, the first pass execution module 410 selects an object in the video frame 402. The first pass execution module 410 receives inference results from the SOCs 346. The first pass execution module 410 evaluates the confidence levels to filter unreliable detections. The first pass execution module 410 further can select an object based on the confidence levels. In some embodiments, the user profile(s) 308 are used to prioritize object categories determined by object cohorts.

Then, the first pass execution module 410 crops the selected object using the bounding box included in the inference results. The first pass execution module 410 receives bounding box coordinates associated with the selected object identified in the video frame 402. The first pass execution module 410 uses the bounding box coordinates to determine a region within the video frame 402 corresponding to the selected object. The first pass execution module 410 crops the determined region from the video frame 402 to generate the selected cropped object 412.

The second pass execution module 420 operates as follows. First, the second pass execution module 420 receives the selected cropped object 412 generated by the first pass execution module 410. In some embodiments, the second pass execution module 420 can also receive the video frame 402 and inference results associated with the selected cropped object 412.

Then, the second pass execution module 420 executes a computer vision model on the selected cropped object 412 to generate features of the object. In some embodiments, the computer vision model uses OpenCV. The selected cropped object 412 is smaller than the video frame 402, which optimizes processing load for the embedded system associated with the SOCs 346.

Then, the second pass execution module 420 generates a match by comparing the features of the selected cropped object 412 to matches in the local refinement source 354. The second pass execution module 420 compares the generated features to data stored in the local refinement source 354 to identify a corresponding real-world item. For example, the match could identify a specific brand or product. The match can also be a close match when an exact brand match is not available. In embodiments in which the local refinement source 354 is a database, the second pass execution module 420 compares the generated features to feature or embedding data stored in the database and selects a database entry having a closest match to the generated features. In embodiments in which the local refinement source 354 is a simplified model, the second pass execution module 420 provides the generated features as input to the simplified model to obtain an output indicating a brand or product classification corresponding to the selected cropped object 412.

Then, the second pass execution module 420 obtains a link based on the match. The second pass execution module 420 obtains the item link 422 from the local refinement source 354 based on the match. In some embodiments, the item link 422 includes a URL for additional information about the brand or product associated with the match.

Then, the second pass execution module 420 coordinates display of the item link 422 overlaid on the video frame 402. The second pass execution module 420 provides the item link 422 to the UI engine 302 for display in conjunction with the video frame 402. The UI engine 302 renders the item link 422 within the context of the video frame 402 during a pause state of the streaming engine 306. In some embodiments, the URL included in the item link 422 is converted into a QR code for display using the UI engine 302. The QR code enables a user to capture the QR code and access a website associated with the brand or product corresponding to the match.

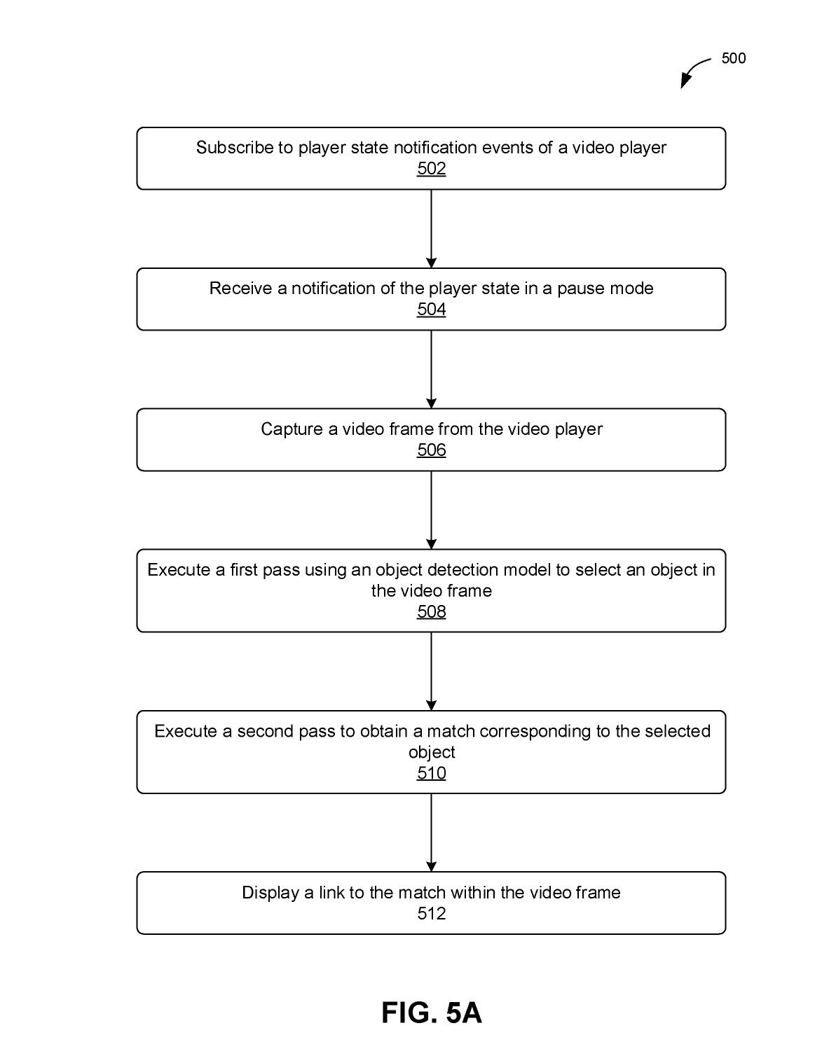

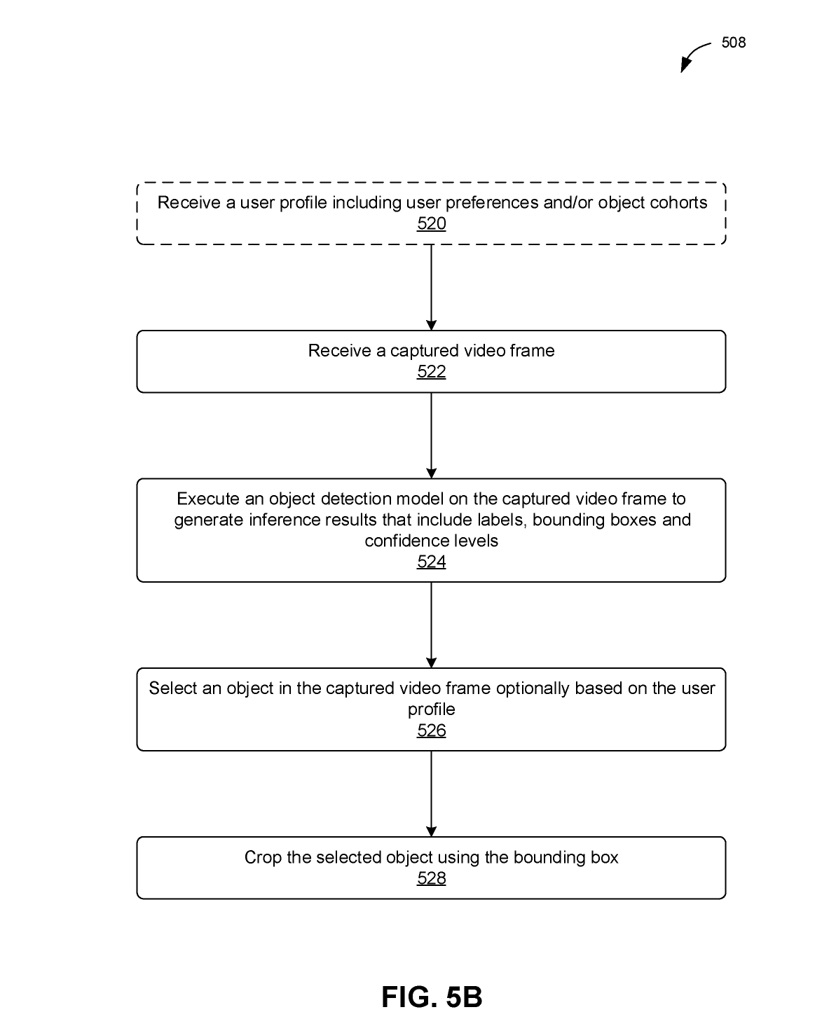

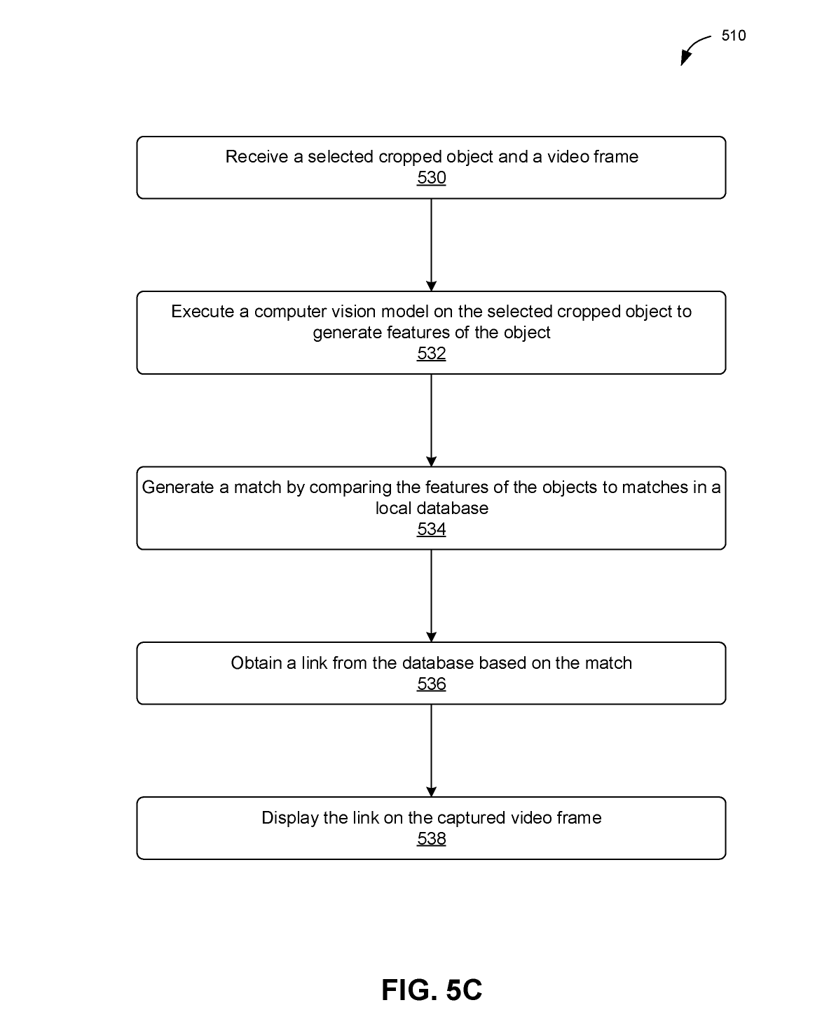

FIG. 5A illustrates a flow diagram of a method 500 for generating a match to an object within a video frame, according to various embodiments. Although the method steps are described in conjunction with the systems of FIGS. 1-4, persons skilled in the art will understand that any system configured to perform the method steps, in any order, is within the scope of the present disclosure.

As shown in FIG. 5A, the method 500 begins at a step 502, where the object matching module 352 subscribes to player state notifications of a video player, as described in FIGS. 1-4. At step 504, the object matching module 352 receives a notification of the player state in a pause mode, as described in FIGS. 1-4. At step 506, the object matching module 352 captures a video frame from the video player, as described in FIGS. 1-4. At step 508, the object matching module 352 executes a first pass using an object detection model to select an object in the video frame, as described in FIGS. 1-4. At step 510, the object matching module 352 executes a second pass to obtain a match corresponding to the selected object, as described in FIGS. 1-4. At step 512, the object matching module 352 displays a link to the match within the video frame, as described in FIGS. 1-4.

FIG. 5B illustrates a more detailed flow diagram of detailed steps of step 508 of FIG. 5A, according to various embodiments. Although the method steps are described in conjunction with the systems of FIGS. 1-4, persons skilled in the art will understand that any system configured to perform the method steps, in any order, is within the scope of the present disclosure.

As shown in FIG. 5B, the step 508 begins at step 520, where the first pass execution module 410 receives the user profile(s) 308 including user preference and/or object cohorts, as described in FIGS. 1-4. At step 522, the first pass execution module 410 receives the captured video frame 402, as described in FIGS. 1-4. At step 524, the first pass execution module 410 executes an object detection model on the captured video frame 402 to generate inference results that include labels, bounding boxes, and confidence levels, as described in FIGS. 1-4. At step 526, the first pass execution module 410 selects an object in the captured video frame 402, optionally based on the user profile(s) 308, as described in FIGS. 1-4. At step 528, the first pass execution module 410 crops the selected object using the bounding box, as described in FIGS. 1-4.

FIG. 5C illustrates a more detailed flow diagram of detailed steps of step 510 of FIG. 5A, according to various embodiments. Although the method steps are described in conjunction with the systems of FIGS. 1-4, persons skilled in the art will understand that any system configured to perform the method steps, in any order, is within the scope of the present disclosure.

As shown in FIG. 5C, the step 510 begins at step 530, where the second pass execution module 420 receives the selected cropped object 412 and the video frame 402, as described in FIGS. 1-4. At step 532, the second pass execution module 420 executes a computer vision model on the selected cropped object 412 to generate features of the object, as described in FIGS. 1-4. At step 534, the second pass execution module 420 generates a match by comparing the features of the object to matches in a local database (e.g., the local refinement source 354), as described in FIGS. 1-4. At step 536, the second pass execution module 420 obtains a link from the database based on the match, as described in FIGS. 1-4. At step 538, the UI engine 302 displays the link on the captured video frame 402, as described in FIGS. 1-4. In some embodiments, the link is displayed in the form of a QR code.

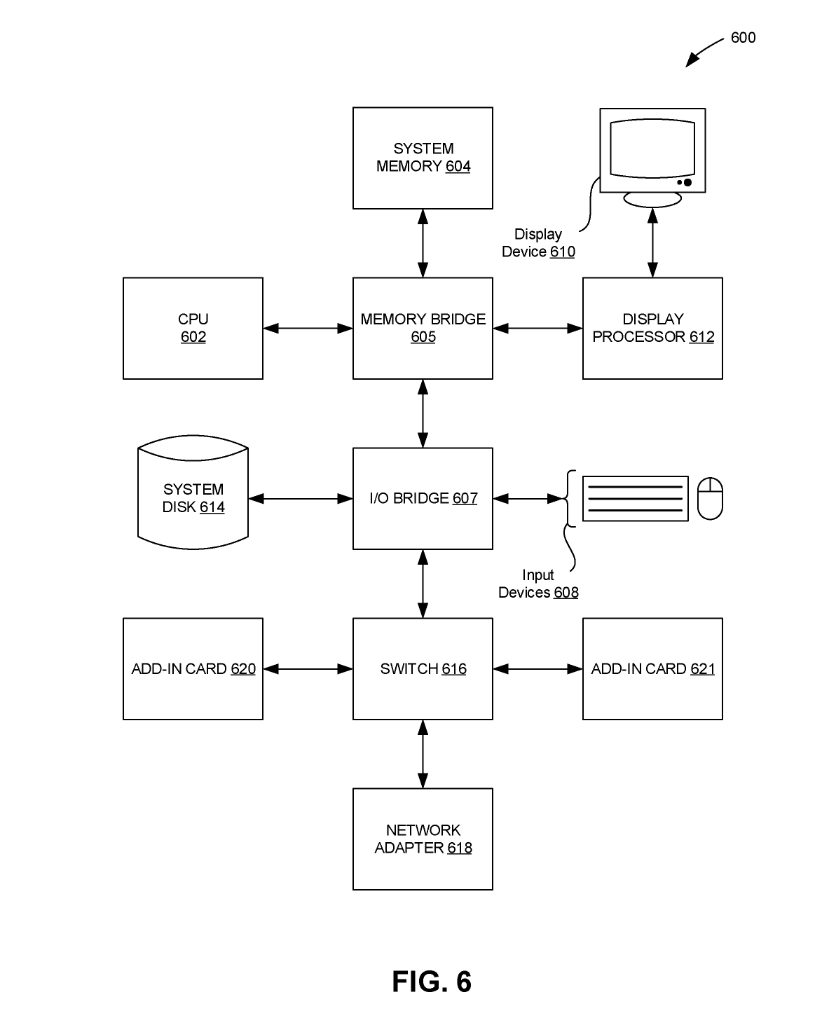

FIG. 6 is a more detailed illustration of a computing device that can implement the functionalities of any of the entities illustrated in FIG. 1, according to various embodiments. FIG. 6 in no way limits or is intended to limit the scope of the various embodiments. In various implementations, system 600 may be an augmented reality, virtual reality, or mixed reality system or device, a personal computer, video game console, personal digital assistant, mobile phone, mobile device, or any other device suitable for practicing the various embodiments. Further, in various embodiments, any combination of two or more systems 600 may be coupled together to practice one or more aspects of the various embodiments.

As shown, system 600 includes a central processing unit (CPU) 602 and a system memory 604 communicating via a bus path that may include a memory bridge 605. CPU 602 includes one or more processing cores, and, in operation, CPU 602 is the master processor of system 600 and controls and coordinates operations of other system components. System memory 604 stores software applications and data for use by CPU 602. CPU 602 runs software applications and optionally an operating system. Memory bridge 605, which may be, e.g., a Northbridge chip, is connected via a bus or other communication path (e.g., a HyperTransport link) to an I/O (input/output) bridge 607. I/O bridge 607, which may be, e.g., a Southbridge chip, receives user input from one or more user input devices 608 (e.g., a keyboard, mouse, joystick, digitizer tablets, touch pads, touch screens, still or video cameras, motion sensors, and/or microphones) and forwards the user input to CPU 602 via memory bridge 605.

A display processor 612 is coupled to memory bridge 605 via a bus or other communication path (e.g., a PCI Express, Accelerated Graphics Port, or HyperTransport link); in one embodiment, display processor 612 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 604.

Display processor 612 periodically delivers pixels to a display device 610 (e.g., a screen or conventional CRT, plasma, OLED, SED, or LCD based monitor or television). Additionally, display processor 612 may output pixels to film recorders adapted to reproduce computer generated images on photographic film. Display processor 612 can provide display device 610 with an analog or digital signal. In various embodiments, one or more of the various graphical user interfaces set forth in FIG. 3 are displayed to one or more users via display device 610, and the one or more users can input data into and receive visual output from the various graphical user interfaces.

A system disk 614 is also connected to I/O bridge 607 and may be configured to store content, applications, and data for use by CPU 602 and display processor 612. System disk 614 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 616 provides connections between I/O bridge 607 and other components such as a network adapter 618 and various add-in cards 620 and 621. Network adapter 618 allows system 600 to communicate with other systems via an electronic communications network and may include wired or wireless communication over local area networks and wide area networks such as the Internet.

Other components (not shown), including USB or other port connections, film recording devices, and the like, may also be connected to I/O bridge 607. For example, an audio processor may be used to generate analog or digital audio output from instructions and/or data provided by CPU 602, system memory 604, or system disk 614. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 612 incorporates circuitry optimized for graphics and video processing, including, for example, video output circuitry, and constitutes a graphics processing unit (GPU). In another embodiment, display processor 612 incorporates circuitry optimized for general purpose processing. In yet another embodiment, display processor 612 may be integrated with one or more other system elements, such as the memory bridge 605, CPU 602, and I/O bridge 607, to form a system on chip (SoC). In still further embodiments, display processor 612 is omitted and software executed by CPU 602 performs the functions of display processor 612.

Pixel data can be provided to display processor 612 directly from CPU 602. In some embodiments, instructions and/or data representing a scene are provided to a render farm or a set of server computers, each similar to system 600, via network adapter 618 or system disk 614. The render farm generates one or more rendered images of the scene using the provided instructions and/or data. The rendered images may be stored on computer-readable media in a digital format and optionally returned to system 600 for display. Similarly, stereo image pairs processed by display processor 612 may be output to other systems for display, stored on system disk 614, or stored on computer-readable media in a digital format.

Alternatively, CPU 602 provides display processor 612 with data and/or instructions defining the desired output images, from which display processor 612 generates the pixel data of one or more output images, including characterizing and/or adjusting the offset between stereo image pairs. The data and/or instructions defining the desired output images can be stored in system memory 604 or graphics memory within display processor 612. In an embodiment, display processor 612 includes 3D rendering capabilities for generating pixel data for output images from instructions and data defining the geometry, lighting, shading, texturing, motion, and/or camera parameters for a scene. Display processor 612 can further include one or more programmable execution units capable of executing shader programs, tone mapping programs, and the like.

Further, in other embodiments, CPU 602 or display processor 612 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments, any of the operations and/or functions described herein can be performed by CPU 602, display processor 612, or one or more other processing devices, or any combination of the different processors.

CPU 602, the render farm, and/or display processor 612 can employ any surface or volume rendering technique known in the art to generate one or more rendered images from the provided data and instructions, including rasterization, scanline rendering, REYES or micropolygon rendering, ray casting, ray tracing, image-based rendering techniques, and/or combinations of the techniques and any other rendering or image processing techniques known in the art.

In other contemplated embodiments, system 600 may be a robot or robotic device and may include CPU 602 and/or other processing units or devices and system memory 604. In such embodiments, system 600 may or may not include other elements shown in FIG. 6. System memory 604 and/or other memory units or devices in system 600 may include instructions that, when executed, cause the robot or robotic device represented by system 600 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 604 is connected to CPU 602 directly rather than through a bridge, and other devices communicate with system memory 604 via memory bridge 605 and CPU 602. In other alternative topologies, display processor 612 is connected to I/O bridge 607 or directly to CPU 602, rather than to memory bridge 605. In still other embodiments, I/O bridge 607 and memory bridge 605 might be integrated into a single chip. The particular components shown herein are optional; for instance, any number of add-in cards or peripheral devices might be supported. In some embodiments, switch 616 is eliminated, and network adapter 618 and add-in cards 620 and 621 connect directly to I/O bridge 607.

In sum, techniques are disclosed for an artificial intelligence (AI) architecture that can be executed on an endpoint device (e.g., a client device) in a streaming environment. The AI architecture includes an edge AI service (EAIS) that mediates between a streaming application and one or more systems on chip (SOCs) that execute AI models on the client device. The EAIS can receive an event from the streaming application using a communication scheme, where the event includes information such as a player state, a request for object detection, a request for voice recognition, a request for picture quality analysis, a request for audio quality analysis, and/or similar information. In response to receipt of the event, the EAIS selects one or more AI model operations of the SOCs, including loading a selected AI model, dispatching an inference request, and executing the AI model on processing units and/or hardware accelerators integrated within the SOCs. The EAIS then receives inference results generated by the AI model. The inference results can include labels, confidence levels, bounding box coordinates, classifications, text outputs, and/or similar outputs. The EAIS then processes the inference results by filtering unreliable detections, selecting relevant objects, and optionally performing additional operations, such as interacting with a database. After processing, the EAIS generates a structured output such as an item link, a text result, and/or a quality adjustment parameter, and returns processed results to the streaming application.

The AI architecture further includes an edge AI interface (EAIF) that interfaces with the SOCs that execute the AI models. The EAIF standardizes invocation of the AI models across different SOC implementations. Different SOC vendors can provide different stacks and can optimize the AI models for specific SOCs, which results in a fragmented framework across different SOCs. The EAIF addresses the fragmented framework via a common interface for loading the AI models, executing the AI models to generate inference results, and retrieving the inference results. The EAIF also provides an interface that dispatches calls to vendor EAIF libraries supplied by SOC vendors. Each vendor EAIF library conforms to a common interface defined by the EAIF while encapsulating hardware-specific execution details for SOCs. The EAIS invokes the EAIF to dispatch calls to the SOCs regardless of SOC type and/or SOC vendor. As a result, the EAIS can initiate AI tasks via the EAIF without being coupled to a particular SOC architecture. The vendor EAIF libraries include hardware-specific implementations for SOCs that enable loading the AI models, running the AI models, and returning outputs generated by the AI models. The EAIF routes requests for execution of the AI models to a correct vendor EAIF library. The EAIF thus enables deployment of AI models across SOC vendors without requiring modifications to streaming application logic or the EAIS by routing requests to the appropriate vendor EAIF library based on SOCs present on the endpoint device.

The AI architecture enables AI-based enhancements in streaming environments, including object detection using a two-pass execution framework. The two-pass execution framework separates general object detection from object matching to balance computational efficiency and identification accuracy on the endpoint device. Further, the two-pass execution framework enables filtering and refinement of AI results before the AI results are shown to a user. In a first pass, an object detection model is executed on a captured video frame. The first pass detects objects within the captured video frame and generates bounding boxes, labels, and confidence levels. The first pass operates in a lightweight manner suitable for execution on the endpoint device. The first pass can filter inference results based on confidence levels and optionally based on a user profile, where the user profile includes contextual user information and preferences. In a second pass, a matching step is performed. The second pass extracts features from a detected object region and performs a match against a local database or a simplified model. The second pass executes on a cropped section of the captured video frame, which reduces processing load during feature extraction. Such reduction in processing load renders the two-pass execution framework suitable for endpoint devices. The match identifies a specific brand or product and generates an associated URL for user interaction. The second pass reduces computational load and allows the AI architecture to adapt matches to geographic and/or user-specific context based on the user profile while maintaining on-device processing for privacy and responsiveness.

At least one technical advantage of the disclosed techniques relative to the prior art is that the disclosed techniques provide artificial intelligence (AI) model compatibility across a range of systems-on-chip (SOC) implementations. More specifically, the disclosed techniques support utilization of SOC implementations ranging from basic implementations to high-performance graphics processing units (GPUs) and Neural Processing Units (NPUs), which enables execution of AI models across varying hardware platforms. More specifically, execution of AI models can be invoked without requiring specific formatting for a specific SOC, rather than requiring rewriting for each specific SOC on a given endpoint device, as with prior art approaches. Another technical advantage of the disclosed techniques is that processing is performed on the endpoint device rather than in the cloud, which reduces latency limitations associated with off-device processing, reduces processing strain on centralized infrastructure, and provides added privacy when implementing AI models into workflows with live events. Further, the disclosed techniques prevent display of unreliable detections such that more relevant outputs of AI models - such as inference results that have been filtered and refined - are displayed to the user.
1. In some embodiments, a computer-implemented method for performing artificial intelligence (AI) processing in a streaming environment on an endpoint device comprises: obtaining media data associated with playback of content by a streaming application executing on the endpoint device; identifying, via at least one AI inference operation executed on the media data, an object represented within the media data; generating refined object data corresponding to the object; generating feature data associated with the object based on the refined object data; obtaining item information associated with the object based on a comparison between the feature data and reference data stored on the endpoint device; and outputting presentation data associated with the item information for display in association with the playback of the content.
2. The computer-implemented method of clause 1, wherein obtaining the media data comprises obtaining a video frame based on state information indicating that playback is paused.
3. The computer-implemented method of any of clauses 1-2, wherein identifying the object comprises generating first inference results comprising a bounding box associated with the object.
4. The computer-implemented method of any of clauses 1-3, wherein generating the refined object data comprises cropping the media data according to the bounding box to isolate a portion of the media data corresponding to the object.
5. The computer-implemented method of any of clauses 1-4, wherein generating the feature data comprises executing a feature embedding operation on the refined object data.
6. The computer-implemented method of any of clauses 1-5, further comprising obtaining user profile data associated with the streaming application, wherein identifying the object is performed based on the user profile data.
7. The computer-implemented method of any of clauses 1-6, wherein obtaining the user profile data comprises maintaining multi-level profile tracking comprising persistent preference data and session-context data.
8. The computer-implemented method of any of clauses 1-7, wherein identifying the object is performed based on an object cohort indicated by the user profile data.
9. The computer-implemented method of any of clauses 1-8, wherein the reference data stored on the endpoint device comprises a database that stores, for each entry of a plurality of entries, embedding data associated with a corresponding object and a corresponding uniform resource locator (URL).
10. The computer-implemented method of any of clauses 1-9, wherein obtaining the item information comprises selecting a database entry having a closest match to the feature data.
11. In some embodiments, one or more non-transitory computer readable media store instructions that, when executed by one or more processors, cause the one or more processors to perform artificial intelligence (AI) processing in a streaming environment on an endpoint device, by performing the operations of: obtaining media data associated with playback of content by a streaming application executing on the endpoint device; identifying, via at least one AI inference operation executed on the media data, an object represented within the media data; generating refined object data corresponding to the object; generating feature data associated with the object based on the refined object data; obtaining item information associated with the object based on a comparison between the feature data and reference data stored on the endpoint device; and outputting presentation data associated with the item information for display in association with the playback of the content.
12. The one or more non-transitory computer readable media of clause 11, further comprising storing at least a portion of the feature data as embedding data in the reference data for a subsequent comparison.
13. The one or more non-transitory computer readable media of any of clauses 11-12, wherein outputting the presentation data comprises outputting a JavaScript Object Notation (JSON) formatted event to a JavaScript engine associated with the streaming application.
14. The one or more non-transitory computer readable media of any of clauses 11-13, wherein the presentation data causes display of a quick response (QR) code encoding a uniform resource locator (URL) included in the item information.
15. The one or more non-transitory computer readable media of any of clauses 11-14, wherein obtaining the media data comprises obtaining a video frame based on state information indicating that playback is paused.
16. The one or more non-transitory computer readable media of any of clauses 11-15, wherein identifying the object comprises generating first inference results comprising a bounding box associated with the object.
17. The one or more non-transitory computer readable media of any of clauses 11-16, wherein generating the refined object data comprises cropping the media data according to the bounding box to isolate a portion of the media data corresponding to the object.
18. The one or more non-transitory computer readable media of any of clauses 11-17, wherein generating the feature data comprises executing a feature embedding operation on the refined object data.
19. The one or more non-transitory computer readable media of any of clauses 11-18, further comprising obtaining user profile data associated with the streaming application, wherein identifying the object is performed based on the user profile data.
20. In some embodiments, a computer system comprises one or more memories that include instructions, and one or more processors that are coupled to the one or more memories and that, when executing the instructions, are configured to perform artificial intelligence (AI) processing in a streaming environment on the computer system, by performing the operations of: obtaining media data associated with playback of content by a streaming application executing on the computer system; identifying, via at least one AI inference operation executed on the media data, an object represented within the media data; generating refined object data corresponding to the object; generating feature data associated with the object based on the refined object data; obtaining item information associated with the object based on a comparison between the feature data and reference data stored on the computer system, and outputting presentation data associated with the item information for display in association with the playback of the content.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a module or system. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing artificial intelligence (AI) processing in a streaming environment on an endpoint device, the method comprising:
obtaining media data associated with playback of content by a streaming application executing on the endpoint device;
identifying, via at least one AI inference operation executed on the media data, an object represented within the media data;
generating refined object data corresponding to the object;
generating feature data associated with the object based on the refined object data;
obtaining item information associated with the object based on a comparison between the feature data and reference data stored on the endpoint device; and
outputting presentation data associated with the item information for display in association with the playback of the content.

2. The computer-implemented method of claim 1, wherein obtaining the media data comprises obtaining a video frame based on state information indicating that playback is paused.

3. The computer-implemented method of claim 1, wherein identifying the object comprises generating first inference results comprising a bounding box associated with the object.

4. The computer-implemented method of claim 3, wherein generating the refined object data comprises cropping the media data according to the bounding box to isolate a portion of the media data corresponding to the object.

5. The computer-implemented method of claim 1, wherein generating the feature data comprises executing a feature embedding operation on the refined object data.

6. The computer-implemented method of claim 1, further comprising obtaining user profile data associated with the streaming application, wherein identifying the object is performed based on the user profile data.

7. The computer-implemented method of claim 6, wherein obtaining the user profile data comprises maintaining multi-level profile tracking comprising persistent preference data and session-context data.

8. The computer-implemented method of claim 6, wherein identifying the object is performed based on an object cohort indicated by the user profile data.

9. The computer-implemented method of claim 1, wherein the reference data stored on the endpoint device comprises a database that stores, for each entry of a plurality of entries, embedding data associated with a corresponding object and a corresponding uniform resource locator (URL).

10. The computer-implemented method of claim 9, wherein obtaining the item information comprises selecting a database entry having a closest match to the feature data.

11. One or more non-transitory computer readable media storing instructions that, when executed by one or more processors, cause the one or more processors to perform artificial intelligence (AI) processing in a streaming environment on an endpoint device, by performing the operations of:
obtaining media data associated with playback of content by a streaming application executing on the endpoint device;
identifying, via at least one AI inference operation executed on the media data, an object represented within the media data;
generating refined object data corresponding to the object;
generating feature data associated with the object based on the refined object data;
obtaining item information associated with the object based on a comparison between the feature data and reference data stored on the endpoint device; and
outputting presentation data associated with the item information for display in association with the playback of the content.

12. The one or more non-transitory computer readable media of claim 11, further comprising storing at least a portion of the feature data as embedding data in the reference data for a subsequent comparison.

13. The one or more non-transitory computer readable media of claim 12, wherein outputting the presentation data comprises outputting a JavaScript Object Notation (JSON) formatted event to a JavaScript engine associated with the streaming application.

14. The one or more non-transitory computer readable media of claim 11, wherein the presentation data causes display of a quick response (QR) code encoding a uniform resource locator (URL) included in the item information.

15. The one or more non-transitory computer readable media of claim 11, wherein obtaining the media data comprises obtaining a video frame based on state information indicating that playback is paused.

16. The one or more non-transitory computer readable media of claim 11, wherein identifying the object comprises generating first inference results comprising a bounding box associated with the object.

17. The one or more non-transitory computer readable media of claim 16, wherein generating the refined object data comprises cropping the media data according to the bounding box to isolate a portion of the media data corresponding to the object.

18. The one or more non-transitory computer readable media of claim 11, wherein generating the feature data comprises executing a feature embedding operation on the refined object data.

19. The one or more non-transitory computer readable media of claim 11, further comprising obtaining user profile data associated with the streaming application, wherein identifying the object is performed based on the user profile data.

20. A computer system, comprising:
one or more memories that include instructions; and
one or more processors that are coupled to the one or more memories and, when executing the instructions, are configured to perform artificial intelligence (AI) processing in a streaming environment on the computer system, by performing the operations of:
obtaining media data associated with playback of content by a streaming application executing on the computer system;
identifying, via at least one AI inference operation executed on the media data, an object represented within the media data;
generating refined object data corresponding to the object;
generating feature data associated with the object based on the refined object data;
obtaining item information associated with the object based on a comparison between the feature data and reference data stored on the computer system; and
outputting presentation data associated with the item information for display in association with the playback of the content.
